(19) United States
(12) Patent Application Publication
(10) Pub. No.: US 2010/0313779 A1
(43) Pub. Date: Dec. 16, 2010

(54) APPARATUS FOR DETECTING PRINTING PLATES AND A PRINTING PLATE MONITORING SYSTEM FOR A PRINTING PRESS

(75) Inventor: Keith Scarfe, Preston Lancashire (GB)

Correspondence Address: LANDO & ANASTASI, LLP, ONE MAIN STREET, SUITE 1100, CAMBRIDGE, MA, 02142, US

(73) Assignee: GOSS GRAPHIC SYSTEMS LIMITED, Preston Lancashire (GB)

(21) Appl. No.: 12/677,456

(22) PCT Filed: Sep. 8, 2008
(86) PCT No.: PCT/EP2008/061857

§ 371 Date: Aug. 24, 2010

(30) Foreign Application Priority Data
Oct. 4, 2007 (GB) 0719360.0

(51) Int. Cl. B41L 47/14

(52) U.S. Cl. 101/477

(57) ABSTRACT

Apparatus for detecting the presence of a partially loaded printing plate in individual printing plate mounting positions on a plate cylinder of a printing press is disclosed. The system includes a discrete vacuum circuit associated with each individual printing plate mounting position. Each vacuum circuit includes suction elements that are positionable spaced from the surface of a plate cylinder so that, when a leading edge of a printing plate has been received in a lock-up slot in a plate cylinder and the plate cylinder is rotated to partially wrap said printing plate around said plate cylinder, a trailing edge portion of a printing plate is deflected away from the surface of the plate cylinder, due to its resilience, against the suction elements. It is thereby possible to generate a negative pressure in the vacuum circuit closed by said trailing edge portion of the printing plate against the suction elements. The existence of a negative pressure can be used to indicate the presence or absence of a partially loaded printing plate in each of the printing plate mounting positions.

The present invention relates to apparatus for detecting printing plates. More specifically, it relates to apparatus for detecting the presence of partially loaded printing plates in individual printing plate positions on a plate cylinder of a printing press during a plate loading cycle, a printing press having a plate cylinder incorporating said apparatus and, a method of detecting the presence of partially loaded printing plates in individual printing plate mounting positions. The invention also provides a printing plate monitoring system and a method for monitoring printing plates on plate cylinders of a press. The printing plate monitoring system provides information to an operator of the press relating to the load status at each printing plate position.

A web offset printing press comprises a number of printing units. Each unit is designed to print matter onto a continuous web of paper as it travels through the print unit. The printed web emerging from each print unit come together in a folding unit which orientates, folds and cuts each web to produce the finished article such as a newspaper or magazine. Each unit contains at least one pair of cylinder groups or print couples comprising a rotatably mounted plate cylinder, to which one or more printing plates are attached and, a rotatably mounted blanket cylinder. The printing unit may incorporate a shaft less drive system in which each cylinder group is driven by its own drive motor that directly drives one of the cylinders of a group via a belt or gear drive and the other cylinder of that group is mechanically coupled to the driven cylinder. An inking system associated with each print couple is operable to feed ink onto the printing plates attached to the plate cylinder as the plate cylinder rotates. As the cylindrical surfaces of the plate and blanket cylinder are in rolling contact, an inked image is transferred from the printing plates onto the blanket cylinder and from the blanket cylinder onto the medium to be printed.

In large scale high volume presses used, for example, in the production of newspapers, multi-colour printing is achieved by providing each print unit with a number of printing couples arranged in pairs which are mounted vertically above one another in a stack so that the paper web travels in a vertically upward direction between each pair of print couples. A unit having four print couple pairs, i.e. eight print couples, is able to print up to four colours on each side of the paper web and is often referred to as a “four-high” unit.

When a press is prepared for a print run, at least one printing plate carrying the image to be printed must be firmly clamped to the plate cylinder of each print couple. Generally, the plate cylinder includes at least one recess or lock-up slot extending longitudinally along the surface of the plate cylinder and into which is received the leading and trailing edge of a printing plate. A clamping mechanism located in the recess engages the leading and trailing edges of an inserted printing plate and firmly holds the printing plate in position during a print run. The number of printing plates that must be attached to the plate cylinder of each print couple depends on the width of the press and whether the plate cylinder carries one or two printing plates around its circumference, i.e. whether it is a “one around” or “two around” plate cylinder. For example, in a double width one-around press, the plate cylinder may carry four printing plates across its width and one printing plate extending circumferentially around its cylindrical surface. Therefore, there could be as many as eight printing plates in a single printing couple pair and thirty-two printing plates in a four high printing unit all of which must be replaced before a new print run can be initiated. When the plate cylinder is of the “two-around” type, the number of printing plates is doubled accordingly. Therefore, it will be appreciated that even in the production of just one newspaper issue, a very large number of printing plates will be required.

It is of utmost importance to ensure that all the printing plates attached to one plate cylinder are located in very precise circumferential and lateral registration with respect to each other. It will also be appreciated that as ink of a different colour is applied to the print medium as it passes through each print couple pair of a print unit, it is also important that the printing plates are in alignment with the printing plates attached to each of the other plate cylinders of the press as any misalignment of a printing plate will result in mis-registration of the different coloured inks applied to the print medium which will reduce the quality of the final print.

To enable accurate location of the printing plates, precise detection and confirmation of the position of each printing plate must be determined during installation onto the plate cylinder. A commonly known method of aligning a printing plate on a plate cylinder and to make sure that it is located in an “in-register” position is to provide the leading edge of each plate with a number of slots that locate on pins in the recess in the plate cylinder into which the leading edge of the printing plate is received when it is attached to a plate cylinder. The position of the slots and pins are predetermined so that, when the pins have been located in the slots, the printing plate is in the correct position and the press operator can be confident that the printing plate will be positioned correctly in relation to other printing plates.

In a conventional printing machine, the press operator loads both the leading and trailing edges of each printing plate onto the plate cylinders manually so that they are accurately located in their predetermined in-register positions. However, it will be appreciated that this activity is very labour intensive and time consuming especially when a large number of printing plates need to be replaced. It also means that the press, or at least individual print units, are rendered inoperable for an extended period of time and this has a significantly detrimental affect on the overall productivity of the press.

In an attempt to reduce the setting-up time, attempts have been made to automate the plate loading process in which printing plates are automatically fed onto, and accurately located on, the plate cylinder by a printing plate feeding mechanism attached to the printing unit. In such systems, the press operator either accurately positions the printing plates in printing plate holders fixed to the printing press adjacent to each of the plate cylinders of the press or, the position of the printing plates is established by position sensors or similar devices whilst the plates are fed onto the plate cylinder.

Although fully automatic plate loading systems have the advantage that no operator input is required to attach the printing plates to the plate cylinder, they are complex and expensive. A compromise is to provide a semi-automatic printing plate loading system for loading and unloading printing plates from the plate cylinders of a press. One semi-automatic plate loading system is known from the Applicant's own earlier PCT application which has now been published as WO06/120171. In this system, an operator has to manually insert the leading edge of each printing plate into its lock-up slot in the plate cylinder of the press but the trailing edges of each printing plate are then inserted into their lock-up slot by the plate loading system. The system known from this application also automatically removes both the leading and trailing edges of the printing plates during a plate removal procedure. Such a system, although not being fully automatic because the leading edge of each plate is still manually inserted into its lock-up slot, still significantly increases the speed and ease by which printing plates may be accurately and efficiently loaded and unloaded from the printing plate cylinders of a printing press.

In addition to providing means for loading and unloading printing plates, WO06/120171 also discloses means for detecting whether each printing plate position on a plate cylinder is occupied by a printing plate and for informing the operator accordingly. However, the plate checking system disclosed in this application is only capable of checking the presence of printing plates that are have already been fully loaded onto the plate cylinder, i.e. both the leading and trailing edges of the printing plate have been received and clamped within their lock-up slots.

Furthermore, the known printing plate check system also relies on a number of vent passages formed in the plate cylinder itself which are blocked by the presence of a printing plate so that, when a group of suction cups associated with a particular printing plate position contacts the surface of a plate located in a printing plate position on the plate cylinder, the vacuum circuit associated with that group of suction cups is closed causing a negative pressure to be generated within that circuit. If, on the other hand, no printing plate is present in that particular printing plate position, the suction cups come into direct contact with the surface of the plate cylinder instead of a printing plate. In this instance, any attempt to generate a vacuum fails because the suction cups extend over the vent passages in the plate cylinder which communicate the vacuum circuit with the atmosphere.

It is desirable to provide means for detecting the presence of a printing plate in each printing plate position on the plate cylinder of a printing press during the loading cycle. That is, after the lead edge of a printing plate has been manually inserted into its lock-up slot but before the trailing edge has been inserted into its lock-up slot using the plate loading apparatus. A check function of this type would be advantageous as it means that the plate loading system need only be operational for those printing plate positions where the outcome of the check has been positive. Furthermore, if a positive determination has been made, the plate loading procedure can proceed automatically as there is no requirement for an operator to “tell” the system to proceed with the plate loading procedure at each printing plate mounting position.

It will also be appreciated that if the outcome of the check is negative, i.e. no partially loaded printing plate is detected in a particular printing plate position, the system will recognise this and terminate the auto-load procedure for that particular printing plate position.

The result of the check function can alternatively or additionally be used to indicate to a press operator the status of the press so that he can quickly ascertain which individual printing plate positions have been supplied with printing plates and those printing plate positions which have still to receive their printing plates, during a plating-up operation. This information is provided in real time, i.e. as each plate cylinder is loaded with plates. Therefore, a press operator can easily determine how many plates have been loaded and the required time necessary to complete the plate-up procedure.

Furthermore, it is also desirable to provide a check function that does not require modification of the plate cylinder to provide it with vent passages or suchlike.

According to the invention, there is provided apparatus for detecting the presence of a partially loaded printing plate in individual printing plate mounting positions on a plate cylinder of a printing press, said system including a discrete vacuum circuit associated with each individual printing plate mounting position, each vacuum circuit including suction elements positionable spaced from the surface of a plate cylinder such that, when a leading edge of a printing plate has been received in a lock-up slot in a plate cylinder and the plate cylinder is rotated to partially wrap said printing plate around said plate cylinder, a trailing edge portion of a printing plate is deflected away from the surface of the plate cylinder, due to its resilience, against the suction elements such that, when the vacuum circuits are activated, a negative pressure is generated in those vacuum circuits closed by said trailing edge portion of the printing plate against the suction elements, the generation of said negative pressure being indicative of the presence of a partially loaded printing plate in said printing plate mounting position.

In one embodiment, the suction elements are positionable spaced from and facing the surface of a plate cylinder such that printing plates pass between the surface of the plate cylinder and the suction elements as the plate cylinder rotates to partially wrap a printing plate around the plate cylinder.

Preferably, the apparatus includes control means to rotate the plate cylinder into a predetermined position to partially wrap a printing plate around the plate cylinder so that the trailing edge portion of said printing plate is deflected away from the surface of the plate cylinder against the suction elements.

The control means may be operable to activate each discrete vacuum circuit to determine the presence of a partially loaded printing plate in respective printing plate mounting positions after said predetermined position of the plate cylinder has been reached.

In one embodiment, the control means is operable to generate a signal indicative of whether a negative pressure has been generated in each discrete vacuum circuit relating to each printing plate mounting position.

The apparatus preferably includes a display, the control means being operable to control the display in dependence on the signal received from each discrete vacuum circuit to indicate to an operator whether a partially loaded printing plate occupies each of said printing plate mounting positions.

The apparatus may also include a memory to receive and store information relating to whether a printing plate should occupy each printing plate mounting position for a particular print task, the control means being operable to compare that information with actual information relating to whether a partially loaded printing plate is present at each printing plate mounting position and to indicate the outcome of that comparison to an operator on the display. The display may be located remote from the press.

In a preferred embodiment, the control means is operable to deactivate the vacuum circuit for a particular printing plate mounting position if no negative pressure is generated for that particular printing plate mounting position.

Preferably, the control means is operable to activate a plate loading sequence to complete loading of partially loaded printing plates onto the plate cylinder. Most preferably, the control means is operable to activate a plate loading sequence only for printing plate mounting positions where a negative pressure is generated.

According to a preferred embodiment, the plate loading sequence comprises gripping the trailing edge portion of a printing plate with the suction elements, deflecting the trailing edge of said printing plate and moving the suction elements towards the plate cylinder so that the trailing edge of the printing plate is inserted into the lock-up slot in the plate cylinder.

The control means can be configured to generate a first pressure in each vacuum circuit that is sufficient to generate a negative pressure for detection of the presence of a printing plate against the suction elements and, if the presence of a printing plate is detected, initiate the plate loading sequence by increasing that pressure to a pressure at which the trailing edge portion of the printing plate is gripped by the suction elements.

The suction elements may be conveniently mounted to a plate loading head, the plate loading head being movable into a position in which the suction elements are spaced from the surface of the plate cylinder such that a trailing edge portion of a printing plate will be deflected away from the surface of the plate cylinder against the suction elements as the plate cylinder rotates and following insertion of a leading edge of the printing plate into a lock-up slot in the plate cylinder.

Advantageously, the plate loading head is lowerable from a stowed position to a position in which said suction elements are spaced above the surface of the plate cylinder for detection of the presence of a plate cylinder prior to carrying out a plate loading sequence.

In one embodiment, the plate loading head is movable from the position in which the suction elements are spaced above the surface of the plate cylinder towards the plate cylinder during a plate loading sequence, such that a trailing edge portion of a printing plate gripped by the suction elements is placed against the plate cylinder.

The plate loading head preferably includes a pusher element movable between retracted and extended positions to deflect the trailing edge of a printing plate held by the suction elements toward the plate cylinder so that the trailing edge deflected by the pusher element slides into the trailing edge lock-up slot as the plate loading head moves towards the plate cylinder.

In one embodiment, the plate loading head is movable away from the plate cylinder prior to moving it toward the plate cylinder during a plate loading sequence, the pusher element being movable from its retracted to its extended position to deflect the trailing edge of a printing plate prior to movement of the plate loading head towards the plate cylinder.

Preferably, a blanket cylinder is positioned such that, as the plate cylinder rotates to wrap a printing plate around the plate cylinder, a leading edge portion of the printing plate passes through a nip between the plate and blanket cylinders to hold the printing plate against the plate cylinder prior to activation of the vacuum circuit to detect the presence of a partially loaded printing plate.

In one embodiment, the suction elements are positioned relative to the nip between the plate and blanket cylinders such that the leading edge portion of the printing plate passes through the nip and is held against the plate cylinder by the blanket cylinder when the plate cylinder has rotated into a position in which the trailing edge portion of the printing plate is deflected away from the surface of the plate cylinder against the suction elements.

A pressure roller preferably lies in engagement with the plate cylinder to applying pressure to the printing plates as they pass out of the nip between the plate and blanket cylinders, to push the printing plates against the plate cylinder as the plate cylinder rotates.

According to another aspect of the invention, there is provided a rotary web-offset printing press comprising a plate cylinder and the apparatus for detecting the presence of a partially loaded printing plate in individual printing plate mounting positions on said plate cylinder, according to the invention.

According to yet another aspect of the invention, there is provided a printing press plate monitoring system comprising means for detecting whether a printing plate is actually located in individual printing plate mounting positions on plate cylinders of a printing press, means for comparing the outcome of that detection with information relating to whether a printing plate should be located at each individual printing plate mounting position stored in a memory and, means for notifying an operator the result of that comparison for each printing plate mounting position.

In one embodiment, the means for notifying an operator is configured to notify the operator when information obtained as a result of the detection does not match information stored in the memory.

Preferably the system includes a display and the means for notifying the operator is configured to display information relating to the outcome of the comparison on the display.

In one embodiment, the display may be configured to display information relating to the presence or absence of printing plates at every individual printing plate mounting position on the plate cylinder of a printing press in dependence on the outcome of the means for detecting the presence or absence of printing plates at each individual printing plate position.

According to another aspect of the invention, there is provided a method of detecting the presence of a partially loaded printing plate in individual printing plate mounting positions on a plate cylinder of a printing press, the method including the step of locating a leading edge of a printing plate in a lock-up slot in the plate cylinder, rotating the plate cylinder so as to wrap the printing plate around the plate cylinder so that a trailing edge of the printing plate deflects away from the plate cylinder towards suction elements of a discrete vacuum circuit associated with each printing plate mounting position due to the resilience of the printing plate, the method including the step of activating the discrete vacuum circuit associated with each printing plate mounting position to generate a negative pressure in each vacuum circuit closed by the trailing edge portion of a printing plate, and detecting the presence of a partially loaded printing plate in dependence on the generation of said negative pressure.

The step of rotating the plate cylinder preferably comprises rotating the plate cylinder into a predetermined position to wrap a leading edge portion of the printing plate around the plate cylinder so as to leave the trailing edge portion deflected away from the surface of the plate cylinder and against the suction elements.

In one embodiment, the method includes the step of activating each discrete vacuum circuit to determine the presence of a partially loaded printing plate in respective printing plate mounting positions after said predetermined position of the plate cylinder has been reached.

Preferably, the system includes a display and the method includes the step of controlling the display in dependence on the signal received from each discrete vacuum circuit to indicate to an operator whether a partially loaded printing plate occupies each of said printing plate mounting positions.

Advantageously, the system includes a memory to store information relating to whether a partially loaded printing plate should occupy each printing plate mounting position, the method including the step of comparing the stored information with actual information relating to whether a partially loaded printing plate occupies each printing plate mounting position and displaying the outcome of that comparison to an operator on the display.

The method may include the step of displaying said information at a location remote from the press.

In one embodiment, the method includes the step of deactivating the vacuum circuit for a particular printing plate mounting position if no negative pressure is generated for that particular printing plate mounting position.

In one embodiment the method may include the step of activating a plate loading sequence to complete the loading of partially loaded printing plates onto the plate cylinder. In particular, it may include the step of activating a plate loading sequence only for printing plate mounting positions where a negative pressure is generated to indicate the presence of a partially loaded printing plate.

The method may include the step of generating a first pressure in the vacuum circuit that sufficient to generate a negative pressure for detection of the presence of a printing plate against the suction elements and increasing that pressure to a pressure at which the trailing edge portion of the printing plate is gripped by the suction elements during the plate loading sequence, if the presence of a printing plate is detected.

According to another aspect of the invention, there is provided a method of monitoring printing plates on plate cylinders of a printing press comprising the steps of detecting whether a printing plate is actually located in individual printing plate mounting positions on plate cylinders of a printing press, comparing the outcome of that detection with information relating to whether a printing plate should be located at each individual printing plate mounting position stored in a memory and, notifying an operator as to the result of that comparison for each printing plate mounting position.

The means for notifying an operator may be configured to notify the operator when information obtained as a result of the detection does not match information stored in the memory.

The step of notifying an operator can comprise displaying information relating to the outcome of the comparison on a display.

The method can include the step of displaying information relating to the presence or absence of printing plates at every individual printing plate mounting position on the plate cylinder of a printing press in dependence on the outcome of the means for detecting the presence or absence of printing plates at each individual printing plate position.

Embodiments of the invention, will now be described, by way of example only, and with reference to the accompanying drawings, in which:

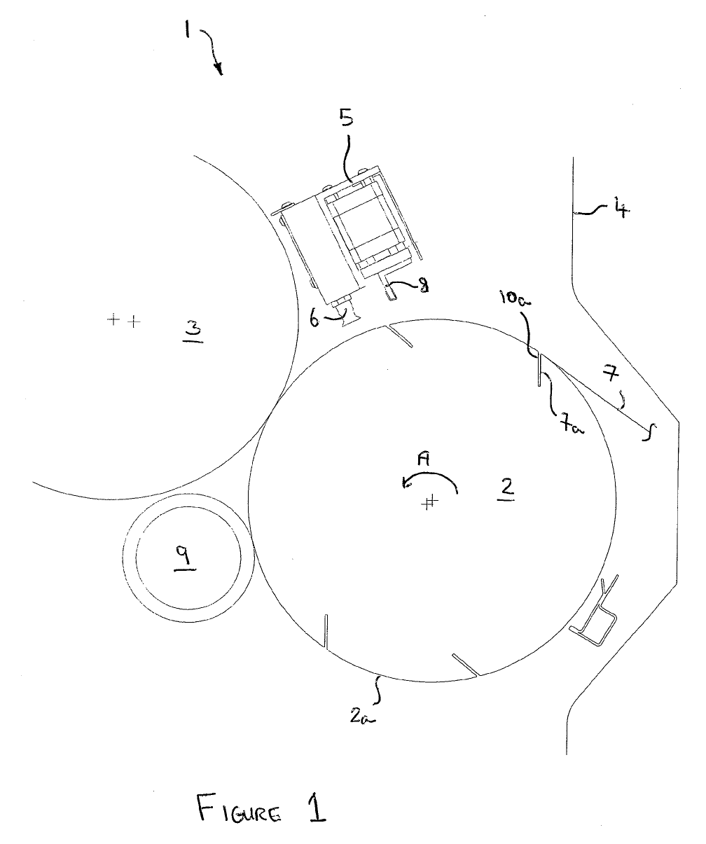

FIG. 1 is a schematic side sectional view through a portion of a print unit of a rotary off-set printing press in which can be seen a plate cylinder, part of a blanket cylinder of one print couple and apparatus for detecting the presence of a printing plate including a plate loading head incorporating suction elements;

FIG. 2 shows a partial enlarged view of the section shown in FIG. 1 after the lead edge of a printing plate has been inserted into its lock-up slot in the plate cylinder and the plate cylinder has been indexed to a position in which the printing plate has been partially wrapped around the circumference of the plate cylinder with a trailing edge portion of the printing plate deflected away from the surface of the plate cylinder and lying in contact with the suction elements of the detection/plate loading apparatus;

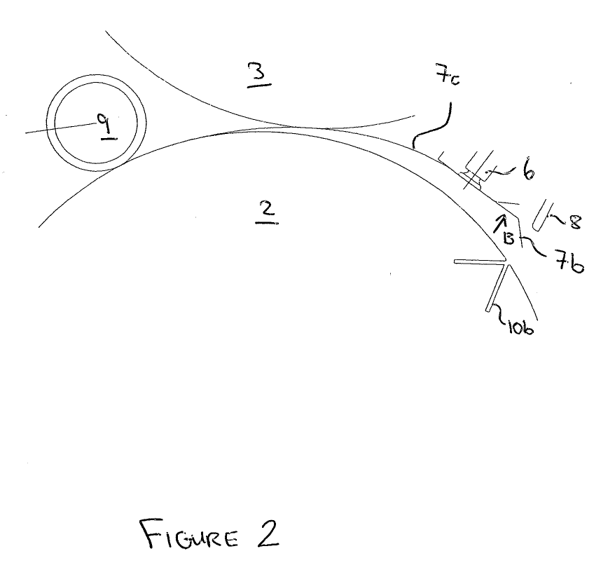

FIG. 3 shows the same view as FIG. 2 but after the pusher element has contacted the trailing edge of the printing plate to deflect it towards the plate cylinder and before the plate, engaged by the suction elements, is lowered towards the surface of the plate cylinder;

FIG. 4 shows the same view as FIG. 3 but after the trailing edge portion of the printing plate has been lowered onto the plate cylinder and the trailing edge has been inserted into its lock-up slot;

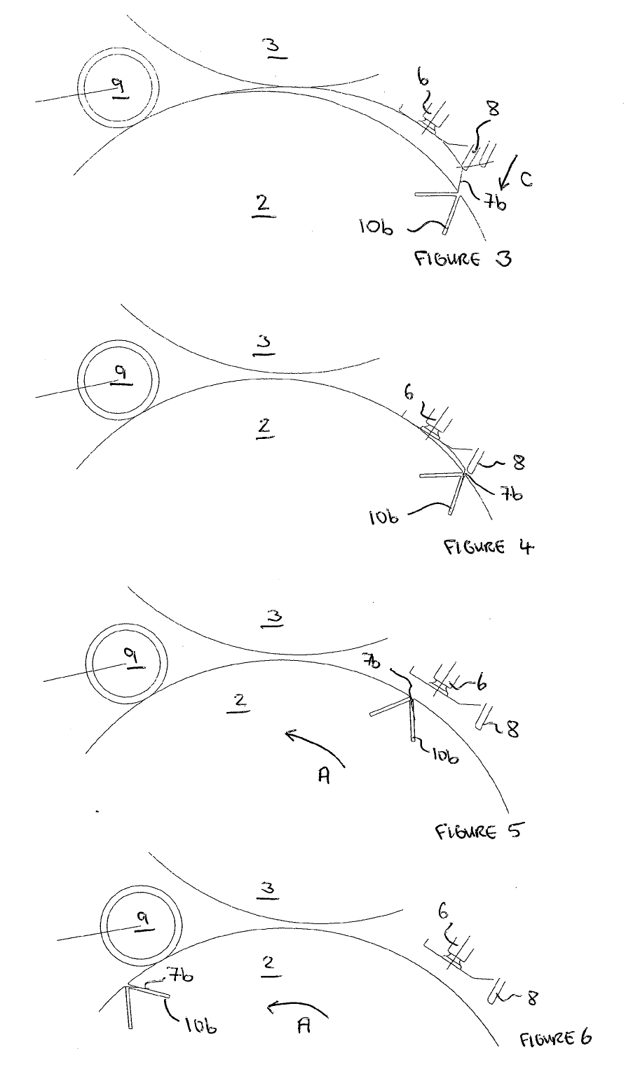

FIG. 5 shows the same view as FIG. 4 but after the suction elements have been deactivated and lifted off the printing plate;

FIG. 6 shows the same view as FIG. 5 but after the plate cylinder has been rotated further so that the trailing edge lock-up slot passes through the nip between the plate and blanket cylinders and the nip between the plate cylinder and the pressure roller;

Referring now to the drawings, there is shown in FIG. 1 a side-sectional view of a portion of a printing unit 1 of a rotary offset printing press according to an embodiment of the present invention showing the plate and blanket cylinders 2,3 of one cylinder group or print couple mounted within a frame 4. As already explained above, each print unit 1 of the press includes multiple cylinder groups, although only one group is illustrated and described in detail. It will be appreciated that, for a complete 4-high printing tower, 8 sets of the apparatus will be required, one for each print couple.

The apparatus for detecting the presence of partially loaded printing plates in discrete printing plate mounting positions on the plate cylinder 2 of the press is integrated with a plate loading/unloading head 5 which includes a number of suction elements 6 grouped into each printing plate position. The suction elements 6 of each group are connected to a discrete vacuum circuit, separate to the vacuum circuit of neighbouring groups, that is sufficient to generate a vacuum pressure to grip and lift printing plates 7, or at least the trailing edge portions of the printing plates 7, away from the surface of the plate cylinder 2 or, lower them towards the surface of the plate cylinder 2. However, it will be appreciated that the printing plate detection apparatus of the present invention may be incorporated into a separate apparatus distinct from the plate loading apparatus, i.e. there may be an entirely separate set of suction elements 6 whose sole purpose is to detect the presence of partially loaded printing plates 7 and which are not used to grip or move the plates 7 once a positive detection has been made. The plate detection apparatus can be simplified if it is incorporated into the plate loading apparatus because the same suction elements 6 and associated vacuum circuits can be used for both printing plate detection and loading. Therefore, the embodiments described in more detail below take this configuration.

In FIG. 1, the plate loading head 5 is shown in a plate detection position in which the suction elements 6 are located close to, but spaced from, the surface 2a of the plate cylinder 2. The plate loading head 5 can be moved into this position from a stowed position (not shown). The plate loading head 5 will occupy the stowed position when no plate loading or plate detection operations are being performed, such as when the printing press is in use. Movement of the plate loading head between the stowed position and the position shown in FIG. 1, as well as movement during a plate loading operation, can be automatically controlled with compressed air or hydraulic cylinders.

The plate loading/unloading head 5 includes an elongate support frame that extends substantially across the entire width of the plate cylinder 2. The plate loading/unloading head 5 also includes a pusher element 8 depending from the support frame adjacent to and extending in the same direction as the suction cups 6. The pusher element 8 is independently movable relative to the support frame and to the suction cups 6 in a direction towards and away from the plate cylinder 2.

The system includes a pressure roller 9, which also extends across the length of the plate cylinder 2 and may be moved into or out of engagement with the surface of the plate cylinder 2. When the pressure roller 9 is in engagement with the plate cylinder 2, it rotates together with the plate cylinder 2 and the nip between them ensures that the leading and trailing edges 7a,7b of any printing plates 7 located on the plate cylinder 2 are pushed fully home into their lock-up slots 10a,10b as the printing plates 7 pass through this nip on rotation of the plate cylinder 2.

The detection of partially loaded printing plates in individual printing plate positions can be best understood by describing a printing plate loading operation as follows:

The printing press or, at least the pair of print couples for which the printing plates 7 are to be loaded, are taken off-line. The plate cylinder 2 is then indexed by rotating it in the direction of arrow “A”. It will be appreciated that rotation of the plate cylinder 2 during an indexing step is considerably slower than any rotational speed that may be achieved during actual running of the press. The plate cylinder 2 is indexed to a circumferential position in which the leading edge lock-up slot 10a is accessible to an operator. This position is generally indicated by the position of the plate cylinder 2 as shown in FIG. 1. With the leading edge lock-up slot 10a in this position, the operator can now manually insert the leading edge 7a of a set of printing plates in their correct positions and as guided by positioning pins (not shown) in the slot 10a and corresponding slot (not shown) in the lead edge 7a of the printing plate 7, as is conventional.

Once the lead edges 7a of a set of printing plates 7 have been inserted into the lead edge lock-up slot 10a in the plate cylinder 2, so that they are effectively hanging from the lead edge lock-up slot 10a, the plate cylinder 2 is indexed in the same direction (the direction of arrow “A” in FIG. 1), so that the printing plates 7 are wrapped around the plate cylinder 2. The weight and flexibility of the printing plates 7 effectively cause them to follow the curvature of the surface 2a of the plate cylinder 2. As the plate cylinder 2 rotates, the printing plates 7 passes through the gap between the suction cups 6 on the plate loading head 5 and the surface 2a of the plate cylinder 2 and the lead edge 7a of the printing plates 7 pass through the nip between the plate and blanket cylinders 2,3 and, through the nip between the plate cylinder 2 and pressure roller 9. As the printing plates 7 pass through these nips, pressure is applied to the printing plates 7 which forces the lead edge 7a into its lock-up slot 10a and pushes the printing plates 7 against the surface 2a of the plate cylinder 2 and holds them in place.

Rotation of the plate cylinder 2 is stopped when the trailing edge 10b of the printing plates 7 approach the gap between the plate loading head 5 and the surface 2a of the plate cylinder 2. This position is shown in FIG. 2. In this position, the printing plates 7 are held in position against the plate cylinder 2 as they extend through the nip between the plate and blanket cylinders 2,3 and, between the pressure roller 9 and plate cylinder 2. However, in this position, a trailing edge portion 7c of the printing plates 7 does not lie against the surface of the plate cylinder but springs-up or is deflected away from its surface (in the direction of arrow “B” in FIG. 2) due to the resilience of the printing plates 7 which tends to want them to remain flat rather than form an arcuate shape defined by the curved surface 2a of the plate cylinder 2 around which they are being wrapped. The suction elements 6 are positioned spaced from the plate cylinder 2 so that when the trailing edge 7b of the printing plates 7 deflect away from the surface 2a of the plate cylinder 2, the upper surface of the printing plates 7 lies in contact with the suction elements 6, as shown in FIG. 2. In fact, the suction elements 6 are positioned relative to the plate cylinder 2 so that they press against the suction elements 6 which prevents further deflection of the trailing edge portion 7c of the printing plates 7 away from the surface 2a of the plate cylinder 2.

Once the plate cylinder 2 has reached the position shown in FIG. 2, the discrete vacuum circuits associated with each individual printing plate position are activated. It will be appreciated that, if a partially loaded printing plate is present in a particular printing plate mounting position, a negative pressure will be generated in that vacuum circuit for that printing plate position because the presence of the printing plate against the suction elements 6 closes that discrete vacuum circuit and enables such a negative pressure to be generated.

The system includes a control unit (not shown) to detect whether a negative pressure has been generated in each discrete vacuum circuit. In the event that a negative pressure is sensed by the control unit, then this provides a positive determination that a partially loaded printing plate 7 is present at that particular printing plate loading position. If, on the other hand, no negative pressure is generated, then this provides a negative determination to signify that there is no partially loaded printing plate 7 at that particular printing plate mounting position. Information relating to the presence or absence of a partially loaded printing plate at each printing plate mounting position as detected by the printing plate detection system can be shown to an operator on a display unit which may be adjacent to the press and/or in a separate press room remote from the press itself.

If a positive determination of the presence of a partially loaded printing plate 7 is made, then the control unit can control the print loading head 5 to insert the trailing edge 7b of the partially loaded printing plate 7 into its lock-up slot 10b. However, if a negative determination is made for a particular printing plate position, then the plate loading sequence for that particular position can be terminated with no further vacuum pressure generated in the associated vacuum circuit.

The trailing edge loading sequence that is followed once a positive determination that a partially loaded printing plate is present will now be described with reference to FIGS. 3 to 6.

During the detection step, the printing plates 7 contact the suction elements 6 and close a vacuum circuit. The same suction elements 6 can now also be used to grip the plate 7 and lift the trailing edge portion 7c and trailing edge 7 slightly further away from the surface of the plate cylinder 2. Next, the pusher element 8 is activated so that it moves in the direction of arrow “C” in FIG. 3, so as to deflect the trailing edge 7b of the printing plate towards the surface 2a of the plate cylinder 2, as shown in FIG. 3. This deflection causes the trailing edge 7b to align at the same angle as the trailing edge lock up slot 10b in the plate cylinder 2 so that, when the plate loading head 5 is lowered, the trailing edge 7b of the printing plates 7 drop into their lock-up slot 10b in the plate cylinder 2, as shown in FIG. 4. The printing plates 7 are then released by deactivating the vacuum circuit, the pusher element 8 is retracted and the plate loading head 5 is raised, as shown in FIG. 5. Finally, the plate cylinder 2 is indexed once again by rotating it in the direction of arrow “A” so that the trailing edge lock up slot 10b passes through the nip between the plate and blanket cylinders 2,3 and, between the pressure roller 9 and the plate cylinder 2 to push the printing plates 7 fully “home” into their lock-up slots 10a,10b and settle the plates 7 against the curved surface 2a of the plate cylinder 2. The pressure roller 9 is then retracted out of contact with the plate cylinder 2. The loading process is now complete and the printing couple may now be placed back on-line and a print run initiated.

It will be appreciated that in order to detect the presence of a partially loaded printing plate 7, the vacuum generated through each vacuum circuit need only be sufficient to detect whether a negative pressure has been formed due to the closure of the vacuum circuit by the presence of a printing plate 7. Such pressure is not required to manipulate or lift the trailing edge portion 7c of the printing plates 7. Therefore, it is envisaged that each vacuum circuit could generate an initial low level vacuum pressure sufficient to determine the presence of a partially loaded printing plate 7 and, only when a positive determination has been made, the vacuum pressure can be increased to perform the loading steps referred to above. If no printing plate 7 is present at any printing plate mounting position, then there will be no increase in vacuum pressure and the low-level vacuum pressure will be terminated.

As described above, the plate detection system can be used to notify an operator as to the status of the press, i.e. the presence or absence of partially loaded printing plates at each printing plate loading position. Although detection of printing plates occurs whilst the plates are only partially loaded, in the sense that only the lead edge of each printing plate has been received in its lock-up slot, as the plate loading cycle can be controlled so as to proceed automatically on receiving confirmation that a partially loaded printing plate is present in a particular printing plate load position. Therefore, detection of a partially loaded printing plate effectively provides confirmation that a loaded printing plate is present (or is about to be present once the loading procedure has been completed) at that particular printing plate loading position.

It is envisaged that the display will provide information to an operator for each and every printing plate position on each plate cylinder of the whole press. To this end, the display can take the form of a plate map in which each printing plate position is shown separately such as by a box or other indicator. The presence or absence of a printing plate in each printing plate position can then be illustrated by different colours or by displaying the box in a different way, such as, for example, filling it in or placing a cross “X” in it to indicate the presence or absence of a printing plate.

In a conventional press, it is usual to program a plate management software system with details of the next print job or task. The system then calculates the optimum arrangement or configuration to perform that job and allocates printing plate positions accordingly. This information can then be displayed on a display close to the press itself which can then be followed by an operator loading the plates onto the plate cylinders. However, it is not possible to provide any information to a press room remote from the press as to whether the printing plates have been loaded, loaded correctly or, at what stage the loading process has reached to enable a determination of how much time is still required to complete the plating up of the press for that job. However, with the present invention, once the leading edge of a set of printing plates have been placed in the lock-up slot of one plate cylinder, the loading procedure for that plate cylinder is initiated and the plate detection check is performed. As a result of that check, the display is automatically updated to indicate which plates have been loaded so that it is possible to quickly determine how many plate cylinders have been loaded and how many are still awaiting their plates. Therefore, the printing plate status of the press is updated in real time, as and when each plate cylinder is loaded with plates.

Another advantage is that, if a plate is positioned in the wrong plate loading position for that job, the system will recognise this during the check stage and a notification will appear on the display to indicate that a printing plate has been loaded into a plate position where no printing plate is required for that job or, that a printing plate is missing.

It will also be appreciated that the system can be used to effect edition changes in which only some of the printing plates need to be changed. In this instance, the software indicates on the display which plates need to be removed and which are to remain in place.

Many modifications and variations of the invention falling within the terms of the following claims will be apparent to those skilled in the art and the foregoing description should be regarded as a description of the preferred embodiments only.

1. Apparatus for detecting the presence of a partially loaded printing plate in individual printing plate mounting positions on a plate cylinder of a printing press, said system including a discrete vacuum circuit associated with each individual printing plate mounting position, each vacuum circuit including suction elements positionable spaced from the surface of a plate cylinder such that, when a leading edge of a printing plate has been received in a lock-up slot in a plate cylinder and the plate cylinder is rotated to partially wrap said printing plate around said plate cylinder, a trailing edge portion of a printing plate is deflected away from the surface of the plate cylinder, due to its resilience, against the suction elements such that, when the vacuum circuits are activated, a negative pressure is generated in those vacuum circuits closed by said trailing edge portion of printing plates against the suction elements, the generation of said negative pressure being indicative of the presence of a partially loaded printing plate in said printing plate mounting position.

2. Apparatus according to claim 1, wherein the suction elements are positionable spaced from and facing the surface of a plate cylinder such that printing plates pass between the surface of the plate cylinder and the suction elements as the plate cylinder rotates to partially wrap a printing plate around the plate cylinder.

3. Apparatus according to claim 1, including control means to rotate the plate cylinder into a predetermined position to partially wrap a printing plate around the plate cylinder so that the trailing edge portion of said printing plate is deflected away from the surface of the plate cylinder against the suction elements.

4. Apparatus according to claim 3, wherein the control means is operable to activate each discrete vacuum circuit to determine the presence of a partially loaded printing plate in respective printing plate mounting positions after said predetermined position of the plate cylinder has been reached.

5. Apparatus according to claim 3, wherein the control means is operable to generate a signal indicative of whether a negative pressure has been generated in each discrete vacuum circuit relating to each printing plate mounting position.

6. Apparatus according to claim 5, including a display, the control means being operable to control the display in dependence on the signal received from each discrete vacuum circuit to indicate to an operator whether a partially loaded printing plate occupies each of said printing plate mounting positions.

7. Apparatus according to claim 6, including a memory to receive and store information relating to whether a printing plate should occupy each printing plate mounting position for a particular print task, the control means being operable to compare that information with actual information relating to whether a partially loaded printing plate is present at each printing plate mounting position and to indicate the outcome of that comparison to an operator on the display.

8. Apparatus according to claim 6, wherein the display is located remote from the printing press.

9. Apparatus according to claim 3, wherein the control means is operable to deactivate the vacuum circuit for a particular printing plate mounting position if no negative pressure is generated for that particular printing plate mounting position.

10. Apparatus according to claim 3, wherein the control means is operable to activate a plate loading sequence to complete loading of partially loaded printing plates onto the plate cylinder.

11. Apparatus according to claim 10, wherein the control means is operable to activate a plate loading sequence only for printing plate mounting positions where a negative pressure is generated.

12. A press according to claim 10, wherein the plate loading sequence comprises gripping the trailing edge portion of a printing plate with the suction elements, deflecting the trailing edge of said printing plate and moving the suction elements towards the plate cylinder so that the trailing edge of the printing plate is inserted into the lock-up slot in the plate cylinder.

13. Apparatus according to claim 10, wherein the control means is configured to generate a first pressure in each vacuum circuit that is sufficient to generate a negative pressure for detection of the presence of a printing plate against the suction elements and, if the presence of a printing plate is detected, initiate the plate loading sequence by increasing that pressure to a pressure at which the trailing edge portion of the printing plate is gripped by the suction elements.

14. Apparatus according to claim 10, wherein the suction elements are mounted to a plate loading head, the plate loading head being movable into a position in which the suction elements are spaced from the surface of the plate cylinder such that a trailing edge portion of a printing plate will be deflected away from the surface of the plate cylinder against the suction elements as the plate cylinder rotates and following insertion of a leading edge of the printing plate into a lock-up slot in the plate cylinder.

15. Apparatus according to claim 14, wherein the plate loading head is lowerable from a stowed position to a position in which said suction elements are spaced above the surface of the plate cylinder for detection of the presence of a plate cylinder prior to carrying out a plate loading sequence.

16. Apparatus according to claim 15, wherein the plate loading head is movable from the position in which the suction elements are spaced above the surface of the plate cylinder towards the plate cylinder during a plate loading sequence, such that a trailing edge portion of a printing plate gripped by the suction elements is placed against the plate cylinder.

17. Apparatus according to claim 16, wherein the plate loading head includes a pusher element movable between retracted and extended positions to deflect the trailing edge of a printing plate held by the suction elements toward the plate cylinder so that the trailing edge deflected by the pusher element slides into the trailing edge lock-up slot as the plate loading head moves towards the plate cylinder.

18. Apparatus according to claim 17, wherein the plate loading head is movable away from the plate cylinder prior to moving it toward the plate cylinder during a plate loading sequence, the pusher element being movable from its retracted to its extended position to deflect the trailing edge of a printing plate prior to movement of the plate loading head towards the plate cylinder.

19. Apparatus according to claim 1, including a blanket cylinder positioned such that, as the plate cylinder rotates to wrap a printing plate around the plate cylinder, a leading edge portion of the printing plate passes through a nip between the plate and blanket cylinders to hold the printing plate against the plate cylinder prior to activation of the vacuum circuit to detect the presence of a partially loaded printing plate.

20. Apparatus according to claim 19, wherein the suction elements are positioned relative to the nip between the plate and blanket cylinders such that the leading edge portion of the printing plate passes through the nip and is held against the plate cylinder by the blanket cylinder when the plate cylinder has rotated into a position in which the trailing edge portion of the printing plate is deflected away from the surface of the plate cylinder against the suction elements.

21. Apparatus according to claim 19, comprising a pressure roller lying in engagement with the plate cylinder to applying pressure to the printing plates as they pass out of the nip between the plate and blanket cylinders, to push the printing plates against the plate cylinder as the plate cylinder rotates.

22. (canceled)

23. A rotary web-offset printing press comprising a plate cylinder and the apparatus for detecting the presence of a partially loaded printing plate in individual printing plate mounting positions on said plate cylinder, according to claim 1.

24. A printing press plate monitoring system comprising means for detecting whether a printing plate is actually located in individual printing plate mounting positions on plate cylinders of a printing press, means for comparing the outcome of that detection with information relating to whether a printing plate should be located at each individual printing plate mounting position stored in a memory and, means for notifying an operator the result of that comparison for each printing plate mounting position.

25. A printing press plate monitoring system according to claim 24, wherein the means for notifying an operator is configured to notify the operator when information obtained as a result of the detection does not match information stored in the memory.

26. A printing press plate monitoring system according to claim 25, comprising a display, the means for notifying the operator being configured to display information relating to the outcome of the comparison on the display.

27. A printing press plate monitoring system according to claim 26, wherein the display is configured to display information relating to the presence or absence of printing plates at every individual printing plate mounting position on the plate cylinder of a printing press in dependence on the outcome of the means for detecting the presence or absence of printing plates at each individual printing plate position.

28. A method of detecting the presence of a partially loaded printing plate in individual printing plate mounting positions on a plate cylinder of a printing press, the method including the step of locating a leading edge of a printing plate in a lock-up slot in the plate cylinder, rotating the plate cylinder so as to wrap the printing plate around the plate cylinder so that a trailing edge of the printing plate deflects away from the plate cylinder towards suction elements of a discrete vacuum circuit associated with each printing plate mounting position due to the resilience of the printing plate, the method including the step of activating the discrete vacuum circuit associated with each printing plate mounting position to generate a negative pressure in each vacuum circuit closed by the trailing edge portion of a printing plate, and detecting the presence of a partially loaded printing plate in dependence on the generation of said negative pressure.

29. A method according to claim 28, wherein the step of rotating the plate cylinder comprises rotating the plate cylinder into a predetermined position to wrap a leading edge portion of the printing plate around the plate cylinder so as to leave the trailing edge portion deflected away from the surface of the plate cylinder and against the suction elements.

30. A method according to claim 29, including the step of activating each discrete vacuum circuit to determine the presence of a partially loaded printing plate in respective printing plate mounting positions after said predetermined position of the plate cylinder has been reached.

31. A method according to claim 29, including the step of generating a signal indicative of whether a negative pressure has been generated in each vacuum circuit.

32. A method according to claim 31, wherein the press includes a display and the method includes the step of controlling the display in dependence on the signal received from each discrete vacuum circuit to indicate to an operator whether a partially loaded printing plate occupies each of said printing plate mounting positions.

33. A method according to claim 32, wherein the press includes a memory to store information relating to whether a partially loaded printing plate should occupy each printing plate mounting position, the method including the step of comparing the stored information with actual information relating to whether a partially loaded printing plate occupies each printing plate mounting position and displaying the outcome of that comparison to an operator on the display.

34. A method according to claim 33, including the step of displaying said information at a location remote from the press.

35. A method according to claim 28, including the step of deactivating the vacuum circuit for a particular printing plate mounting position if no negative pressure is generated for that particular printing plate mounting position.

36. A method according to claim 28, including the step of activating a plate loading sequence to complete the loading of partially loaded printing plates onto the plate cylinder.

37. A method according to claim 36, including the step of activating a plate loading sequence only for printing plate mounting positions where a negative pressure is generated to indicate the presence of a partially loaded printing plate.

38. A method according to claim 34, including the step of generating a first pressure in the vacuum circuit that sufficient to generate a negative pressure for detection of the presence of a printing plate against the suction elements and increasing that pressure to a pressure at which the trailing edge portion of the printing plate is gripped by the suction elements during the plate loading sequence, if the presence of a printing plate is detected.

39. A method according to claim 28, wherein the suction elements are mounted to a plate loading head and the method includes the step of moving the plate loading head into a position in which the suction elements are spaced from the surface of the plate cylinder such that a trailing edge portion of a printing plate is deflected away from the surface of the plate cylinder against the suction elements as the plate cylinder rotates following insertion of a leading edge of the printing plate into a lock-up slot in the plate cylinder.

40. A method according to claim 39, including the step of lowering the plate loading head from a stowed position to a position in which said suction elements are spaced above the surface of the plate cylinder for detection of the presence of a plate cylinder prior to carrying out a plate loading sequence.

41. A method according to claim 28, wherein the press includes a blanket cylinder and the method includes rotating the plate cylinder to feed the printing plate through a nip between the plate cylinder and blanket cylinder as it is wrapped around the plate cylinder, to hold the printing plate against the plate cylinder prior to activation of the vacuum circuit to detect the presence of a partially loaded printing plate.

42. A method of monitoring printing plates on plate cylinders of a printing press comprising the steps of detecting whether a printing plate is actually located in individual printing plate mounting positions on plate cylinders of a printing press, comparing the outcome of that detection with information relating to whether a printing plate should be located at each individual printing plate mounting position stored in a memory and, notifying an operator as to the result of that comparison for each printing plate mounting position.

43. A method according to claim 42, wherein the means for notifying an operator is configured to notify the operator when information obtained as a result of the detection does not match information stored in the memory.

44. A method according to claim 43, wherein the step of notifying an operator comprises displaying information relating to the outcome of the comparison on a display.

45. A method according to claim 42, including the step of displaying information relating to the presence or absence of printing plates at every individual printing plate mounting position on the plate cylinder of a printing press in dependence on the outcome of the means for detecting the presence or absence of printing plates at each individual printing plate position.
